(19) United States
(12) Patent Application Publication
(10) Pub. No.: US 2007/0076673 A1
(43) Pub. Date: Apr. 5, 2007

(54) System and method to discover and maintain multiple routes in a wireless communication network

(76) Inventor: Avinash Joshi, Orlando, FL (US)

Correspondence Address: MOTOROLA, INC;INTELLECTUAL PROPERTY SECTION, LAW DEPT, 8000 WEST SUNRISE BLVD, FT LAUDERDAL, FL, 33322, US

(21) Appl. No.: 11/240,848

(22) Filed: Sep. 30, 2005

(51) Int. Cl. H04Q 7/24

(52) U.S. Cl. 370/338

(57) ABSTRACT

An improved system and method for discovering and maintaining multiple routes in a wireless communication network (100), in particular, a wireless multi-hopping ad-hoc peer-to-peer communication network (100). The system and method use a combination of proactive and reactive routing protocols to effectively and efficiently discover and maintain multiple routes between nodes (106, 107).

### FIELD OF THE INVENTION

The present invention relates to a system and method for discovering and maintaining multiple routes in a wireless communication network, in particular, a wireless multi-hopping ad-hoc peer-to-peer communication network, through the use of a combination of proactive and reactive routing protocols.

### BACKGROUND

In recent years, a type of mobile communications network known as an “ad-hoc” network has been developed. In this type of network, each mobile node is capable of operating as a base station or router for the other mobile nodes, thus eliminating the need for a fixed infrastructure of base stations. As can be appreciated by one skilled in the art, network nodes transmit and receive data packet communications in a multiplexed format, such as time-division multiple access (TDMA) format, code-division multiple access (CDMA) format, or frequency-divison multiple access (FDMA) format.

More sophisticated ad-hoc networks are also being developed which, in addition to enabling mobile nodes to communicate with each other as in a conventional ad-hoc network, further enable the mobile nodes to access a fixed network and thus communicate with other mobile nodes, such as those on the public switched telephone network (PSTN), and on other networks such as the Internet. Details of these advanced types of ad-hoc networks are described in U.S. patent application Ser. No. 09/897,790 entitled “Ad Hoc Peer-to-Peer Mobile Radio Access System Interfaced to the PSTN and Cellular Networks”, filed on Jun. 29, 2001, in U.S. patent application Ser. No. 09/815,157 entitled “Time Division Protocol for an Ad-Hoc, Peer-to-Peer Radio Network Having Coordinating Channel Access to Shared Parallel Data Channels with Separate Reservation Channel”, filed on Mar. 22, 2001, now U.S. Pat. No. 6,807,165, and in U.S. patent application Ser. No. 09/815,164 entitled “Prioritized-Routing for an Ad-Hoc, Peer-to-Peer, Mobile Radio Access System”, filed on Mar. 22, 2001, now U.S. Pat. No. 6,873,839, the entire content of each being incorporated herein by reference.

As can be appreciated by one skilled in the art, in a dynamic wireless network, such as an ad-hoc network as described above, existing routes between nodes keep breaking due to mobility of nodes or dynamic radio frequency (RF) characteristic of the wireless channel. It is therefore advantageous to have multiple routes ready to be used. However, the operations associated with finding and maintaining multiple routes generally add to overhead.

For example, multipath proactive routing algorithms maintain routes for all the nodes in the network all of the time. This can result in substantial overhead especially when only few nodes communicate with each other at a given time. Proactive routing algorithms can easily be modified to discover and maintain more than one route, but that further increases the overhead.

Alternatively, multipath reactive routing algorithms maintain routes for only those nodes that are needed and only when they are needed. Therefore, these routing protocols generally have low routing overhead compared to proactive algorithms. However, these algorithms suffer from higher latency in finding the routes. Multipath extensions to these algorithms try to find multiple routes in the initial route discovery phase. Nevertheless, these extensions face the problem of unused routes getting stale as they were found during the initial route discovery and were never maintained.

### BRIEF DESCRIPTION OF THE FIGURES

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 is a block diagram of an example ad-hoc wireless communications network including a plurality of nodes employing a system and method in accordance with an embodiment of the present invention; and

FIG. 2 is a block diagram illustrating an example of a mobile node employed in the network shown in FIG. 1.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION

Before describing in detail embodiments that are in accordance with the present invention, it should be observed that the embodiments reside primarily in combinations of method steps and apparatus components related to a system and method for discovering and maintaining multiple routes in a wireless communication network. Accordingly, the apparatus components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

It will be appreciated that embodiments of the invention described herein may be comprised of one or more conventional processors and unique stored program instructions that control the one or more processors to implement, in conjunction with certain non-processor circuits, some, most, or all of the functions of a system and method for discovering and maintaining multiple routes in a wireless communication network described herein. The non-processor circuits may include, but are not limited to, a radio receiver, a radio transmitter, signal drivers, clock circuits, power source circuits, and user input devices. As such, these functions may be interpreted as steps of a method for discovering and maintaining multiple routes in a wireless communication network. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

As discussed in more detail below, the present invention provides an improved system and method for discovering and maintaining multiple routes in a wireless communication network, in particular, a wireless multi-hopping ad-hoc peer-to-peer communication network. Specifically, the present invention provides to a system and method that use a combination of proactive and reactive routing protocols to effectively and efficiently discover and maintain multiple routes between nodes.

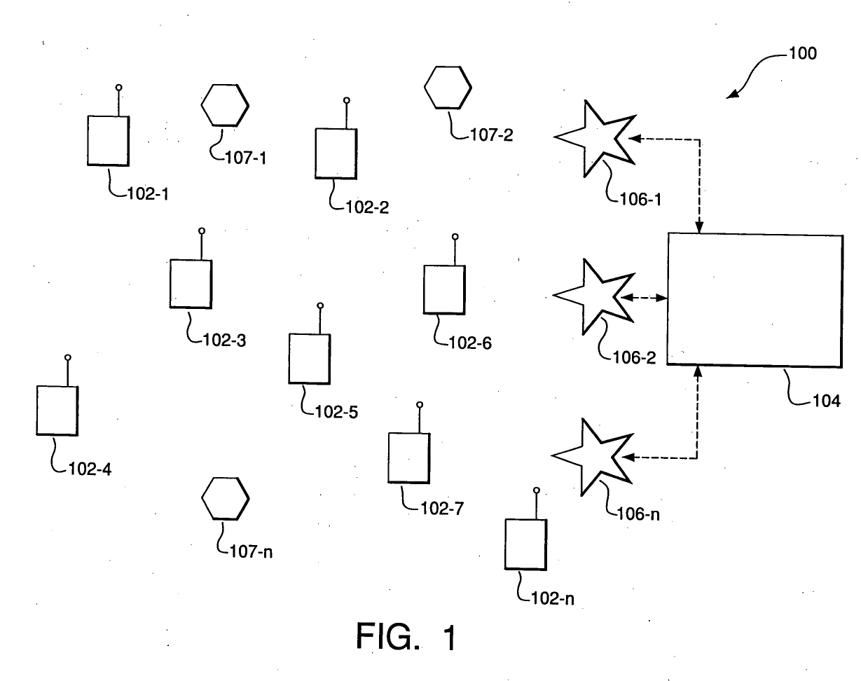

FIG. 1 is a block diagram illustrating an example of an ad-hoc packet-switched wireless communications network 100 employing an embodiment of the present invention. Specifically, the network 100 includes a plurality of mobile wireless user terminals 102-1 through 102-n (referred to generally as nodes 102, mobile nodes 102 or subscriber devices 102), and can, but is not required to, include a fixed network 104 having a plurality of access points 106-1, 106-2, . . . 106-n (referred to generally as nodes 106, intelligent access points 106 or IAPs 106), for providing nodes 102 with access to the fixed network 104. The fixed network 104 can include, for example, a core local access network (LAN), and a plurality of servers and gateway routers to provide network nodes with access to other networks, such as other ad-hoc networks, the public switched telephone network (PSTN) and the Internet. The network 100 further can include a plurality of fixed routers 107-1 through 107-n (referred to generally as nodes 107, wireless routers 107 or WRs 107 ) for routing data packets between other nodes 102, 106 or 107. It is noted that for purposes of this discussion, the nodes discussed above can be collectively referred to as “nodes 102, 106 and 107”, or simply “nodes”.

As can be appreciated by one skilled in the art, the nodes 102, 106 and 107 are capable of communicating with each other directly, or via one or more other nodes 102, 106 or 107 operating as a router or routers for packets being sent between nodes, as described in U.S. patent application Ser. No. 09/897,790 and U.S. Pat. Nos. 6,807,165 and 6,873,839, referenced above.

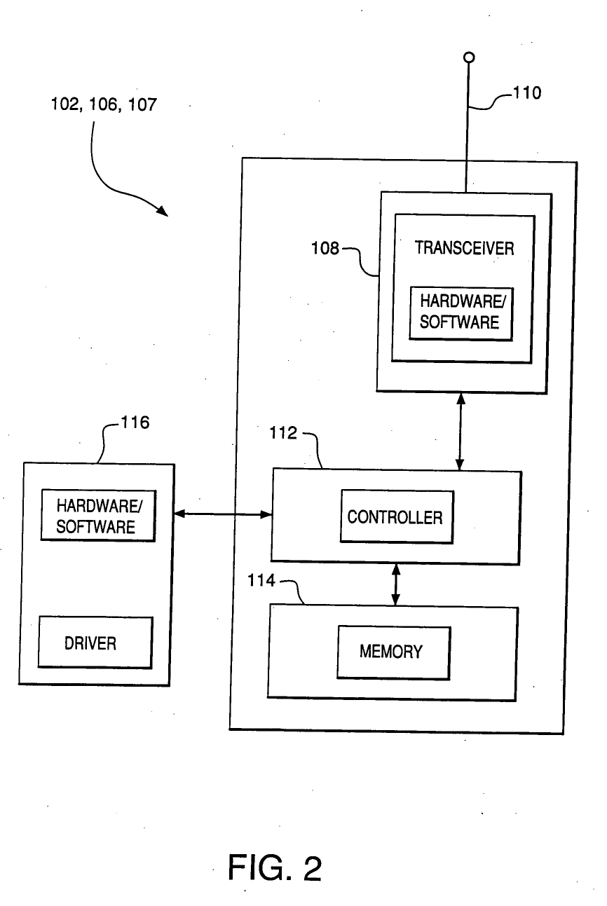

As shown in FIG. 2, each node 102, 106 and 107 includes a transceiver, or modem 108, which is coupled to an antenna 110 and is capable of receiving and transmitting signals, such as packetized signals, to and from the node 102, 106 or 107, under the control of a controller 112. The packetized data signals can include, for example, voice, data or multimedia information, and packetized control signals, including node update information.

Each node 102, 106 and 107 further includes a memory 114, such as a random access memory (RAM) that is capable of storing, among other things, routing information pertaining to itself and other nodes in the network 100. As further shown in FIG. 2, certain nodes, especially mobile nodes 102, can include a host 116 which may consist of any number of devices, such as a notebook computer terminal, mobile telephone unit, mobile data unit, or any other suitable device. Each node 102, 106 and 107 also includes the appropriate hardware and software to perform Internet Protocol (IP) and Address Resolution Protocol (ARP), the purposes of which can be readily appreciated by one skilled in the art. The appropriate hardware and software to perform transmission control protocol (TCP) and user datagram protocol (UDP) may also be included.

As discussed in the Background section above, in a dynamic wireless network, such as an ad-hoc network, existing routes between nodes keep breaking due to mobility of nodes or other reasons such as interference. It is therefore desirable to discover and maintain multiple routes in a wireless communication network, so that one of these routes can be chosen when an existing route fails, to avoid a break in communication between the nodes. The embodiment of the present invention described below provides a system and method which use a combination of proactive and reactive routing protocols as discussed above to avoid the problems associated with each of these protocols individually while effectively and efficiently discovering and maintaining multiple routes between nodes.

Several performance studies of wireless mesh ad-hoc peer-to-peer networks have shown that on-demand protocols incur lower routing overheads compared to their proactive counterparts. However, these protocols are not without performance problems. For example, high route discovery latency together with frequent route discovery attempts in dynamic networks can affect the performance adversely. Certain multipath on-demand protocols try to alleviate these problems by computing multiple paths in a single route discovery attempt. However, these protocols also suffer from routes getting stale as routes are found during the initial route discovery process and is never refreshed or maintained. Accordingly, the embodiment of the present invention described herein uses a hybrid of proactive and reactive routing protocols to discover and maintain multiple routes that reduces both route discovery latency and routing overheads. These routes can then be used to support multiple levels of quality of service (QoS). The multiple paths can also be used to balance load by forwarding data packets on multiple paths at the same time.

An example of the operations of these techniques according to an embodiment of the present invention will now be described with regard to FIG. 1. As discussed above, network 100 comprises mainly three types of devices, subscriber devices 102, IAPs 106 and WRs 107. An IAP 106 has a wired or otherwise permanent connection (e.g.., a microwave backhaul) to the internet/PSTN (e.g., the fixed network 104), and also provides coverage to the devices within its range. Wireless Routers 107 are present to extend the coverage area of the IAP 106. Subscriber devices 102 are the end devices that will use the services offered by the infrastructure device (IAPs 106 and WRs 107).

In such a network 100, it is advantageous for all the nodes to maintain a valid route to the IAP 106 since a large amount of the traffic (e.g., web browsing, VOIP calls) routes through the IAP 106. If the multi access control (MAC) protocol in such a network is TDMA based, the nodes 102 and 107 also need to know if they have sufficient time slots available between them and the IAP 106. The network should be able to support different levels of QoS. There is also a desire to discover and maintain route between SDs 102 if they need to communicate. These routes also should to have the correct level of QoS support, and the correct number of time slots reserved if, for example, TDMA MAC is used. All the above mentioned criteria are substantially achieved by the embodiment of the present invention described herein.

Specifically, in accordance with an embodiment of the present invention, the infrastructure nodes (IAPs 106 and WRs 107) run a “light” version of Optimized Link State Routing (OLSR) protocol as described, for example, in Request for Comments (RFC) 3626. As the name suggests, OLSR is an optimization of pure link state protocol and hence is a proactive routing protocol. Firstly, OSLR reduces the size of control packets by declaring only a subset of links with its neighbors who are its multipoint relay selectors, instead of all links. Secondly, OSLR minimizes flooding of this control traffic by using only the selected nodes, called multipoint relays, to diffuse the OSLR messages in the network. The idea of multipoint relays is to minimize the flooding of broadcast packets in the network by reducing duplicate retransmission in the same region.

Although OLSR has lower routing overhead than pure link state routing protocol, OLSR still has a fairly expensive process (“expensive” in terms of resource or bandwidth consumption) to determine the multipoint relays. The overhead is especially high if the number of devices within each other's range is high and they are mobile. To reduce the overhead, OLSR can be used only with the infrastructure nodes (i.e., stationary nodes such as IAPs and WRs in this example). Since the likelihood of too many infrastructure nodes being within each other's range is practically zero or at least minimal, this scheme will not suffer from the high overhead normally associated with OLSR. By running OLSR only in infrastructure nodes (e.g., nodes 106 and 107), all the infrastructure nodes that are wireless routers 107 will have multiple routes to each other as well to an IAP 106. Since the infrastructure nodes are typically fixed and are mounted on high poles, the interval between consecutive link state broadcast can be as high as few minutes since network topology is not likely to change in this interval. The nodes 107 can thus maintain N routes towards other infrastructure nodes including IAPs 106, with N being any desired number and, in this example, being greater than one (1). The routes provided by OLSR may not be used to send data but instead, they will be used to limit the broadcast search for optimal routes as explained below.

To maintain routes towards an IAP 106, the nodes 107 will send directed Scouting Packets toward the IAP 106 as described in U.S. patent application of Guenael T. Strutt and Avinash Joshi entitled “A System and Method to Scout for Routes in a Wireless Network”, Ser. No. 10/986,698, filed on Nov. 12, 2004, the entire content of which is incorporated herein by reference. These scouting packets will traverse the multiple paths provided by the OLSR routing protocol. The number of such paths pursued can either be predetermined or can be dynamically determined based on number of active connections. This scouting packet can collect different statistics related to routing and QoS which includes, but are not limited, to the following: exact routing metrics along the route; minimum throughput the route can support; maximum delay data packets may be incurred on the route; maximum jitter data packets will incur on the route; the maximum and minimum priority of the data which is flowing through any node in the route; the maximum and minimum priority of the user who is sending data though any of the node in the route; and if TDMA MAC is used in the system, the scouting packets can figure out the number of time slots available on the route.

Scouting the routes based on the routes created by OLSR is much more suitable than the flooding method generally used for such purpose. Once the N routes provided by OLSR are scouted this manner, the node 107 can decide which one to use depending upon the type of traffic and the QoS requirement. The infrastructure nodes 107 also broadcast this information regularly in a periodic hello message or any other message that is broadcasted periodically.

The subscriber devices 102, on the other hand, will rely on their neighboring infrastructure nodes (mostly WRs 107) or other SDs (if they cannot reach any infrastructure device directly) to communicate with an IAP 106. The subscriber devices 102 should periodically transmit a hello message that will enable the neighboring infrastructure nodes to note their presence in the neighbor table and routing table. The hello message should indicate whether the SD 102 has heard any hello message from any infrastructure node (e.g., WR 107 or IAP 106). This way, other SDs 102 can rebroadcast the hello message for the originator if it cannot reach any infrastructure node directly. The message is broadcasted in source routing fashion as can be appreciated by one skilled in the art, and therefore, when any infrastructure node receives this message the infrastructure node will receive information pertaining to a route to the originator SD 102 that is included in this message. After receiving such a rebroadcasted message, the infrastructure node informs the SD 102 about the reception and also sends a source route message back to the SD 102. Thus, the SD 102 is informed by the source route message about a few infrastructure nodes that can receive its message directly or indirectly. This information is also provided to the IAP 106 with which the SD 102 is associated during the association process. Thus, the IAP 106 will have information about the neighboring infrastructure nodes of the SD 102.

When there is a need for an SD 102 to communicate to some device on the Internet (e.g., via fixed network 104), the SD 102 starts sending packets towards the IAP 106 directly or through one of the neighbors (SD 102 or WR 107) of the SD 102 which can support the required QoS (or time slots) or user/data priority. When there is a need for SD 102 to communicate with another SD 102, the SD 102 can first start sending packets to the IAP 106, for example, directly or through other SDs 102 or WRs 107. The SD 102 also sends a status request message as is described in a U.S. patent application of Avinash Joshi entitled “System and Method for Achieving Continuous Connectivity to an Access Point or Gateway in a Wireless Network Following an On-Demand Routing Protocol, and to Perform Smooth Handoff of Mobile Terminals Between Fixed Terminals in the Network”, Ser. No. 10/755,346, filed on Jan. 13, 2004, the entire content of which is incorporated herein by reference. However, in addition to sending a positive or negative status reply, the IAP 106 also sends the addressees of the infrastructure nodes (e.g., WRs 107) that are neighbors of the destination SD 102. These addresses may also include the addresses of infrastructure nodes that are more than one hop away from the destination in case when destination is not in direct communication range of any infrastructure device. Since OLSR already maintains the route to all infrastructure nodes (e.g., IAPs 106 and WRs 107), some fixed number of directed scouting packets can now be send to find out the statistics about the route as previously discussed. Thus an optimal route can be found between one SD 102 and another.

Although only a few exemplary embodiments of the present invention have been described in detail above, those skilled in the art will readily appreciate that many modifications are possible in the exemplary embodiments without materially departing from the novel teachings and advantages of this invention. Accordingly, all such modifications are intended to be included within the scope of this invention as defined in the following claims.

What is claimed is:

1. A wireless multihopping communication network, comprising:
a plurality of stationary nodes;
a plurality of mobile nodes, each of the mobile nodes being adapted to communicate with at least one of the stationary nodes; and
at least one of the stationary nodes is adapted to determine and maintain a plurality of communication routes to at least one other stationary node, and each of the mobile nodes is adapted refrain from maintaining a plurality of routes to any other mobile node or any of the stationary nodes.

2. A wireless multihopping communication network as claimed in claim 1, wherein:
the stationary nodes comprise a plurality of wireless routers, and at least one access point which is adapted to provide any of the mobile nodes that is associated therewith with access to a network other than the wireless multihopping communication network.

3. A wireless multihopping communication network as claimed in claim 1, wherein:
said at least one stationary node is adapted to use a protocol which is based on an Optimized Link State Routing (OLSR) protocol to determine the plurality of communication routes.

4. A wireless multihopping communication network as claimed in claim 1, wherein:
said at least one stationary node uses the plurality of communication routes to support multiple levels of quality of service (QoS).

5. A wireless multihopping communication network as claimed in claim 1, wherein:
said at least one stationary node is further adapted to forward data packets on the plurality of communication routes at the same time for load balancing.

6. A wireless multihopping communication network as claimed in claim 1, wherein:
said at least one stationary node is adapted to send at least one scouting packet toward said at least one other stationary node to collect information related to routing to determine the plurality of communication routes.

7. A wireless multihopping communication network as claimed in claim 6, wherein:
the information related to routing comprises at least one of the following pertaining to a communication route that said at least one node is determining whether to select as one of the plurality of communication routes: quality of service (QoS) information; routing metrics; minimum throughput the communication route can support; maximum delay data packets may incur on the communication route; maximum jitter data packets may incur on the communication route; the maximum and minimum priority of the data which is flowing through any node along the communication route; the maximum and minimum priority of a user who is to send data though any of the node along the communication route; and a number of time slots available on the communication route when time-division multiple access (TDMA) multi access control (MAC) is used along the route.

8. A wireless multihopping communication network as claimed in claim 1, wherein:
said at least one stationary node is further adapted to send information pertaining to the plurality of communication routes for receipt by at least one of another stationary node and a mobile node.

9. A wireless multihopping communication network as claimed in claim 1, wherein:
at least one of the mobile nodes is adapted to send a message to said at least one stationary node to request a route and said at least one stationary node is further adapted to, in reply, send to said at least one mobile node a message including information pertaining to the plurality of communication routes.

10. A wireless multihopping communication network as claimed in claim 1, wherein:
at least one of the stationary nodes is an access point which is adapted to provide any of the mobile nodes that is associated therewith with access to a network other than the wireless multihopping communication network; and
each of the stationary nodes other than the access point is adapted to determine and maintain a respective plurality of communication routes to at least one other stationary node that is an access point.

11. A method of maintaining communication routes in a wireless multihopping communication network, comprising:
providing a plurality of stationary nodes and a plurality of mobile nodes, each of the mobile nodes being adapted to communicate with at least one of the stationary nodes;
operating at least one of the stationary nodes to determine and maintain a plurality of communication routes to at least one other stationary node; and
controlling each of the mobile nodes to refrain from maintaining a plurality of routes to any other mobile node or any of the stationary nodes.

12. A method as claimed in claim 11, wherein:
the stationary nodes comprise a plurality of wireless routers, and at least one access point which is adapted to provide any of the mobile nodes that is associated therewith with access to a network other than the wireless multihopping communication network.

13. A method as claimed in claim 11, wherein:
said operating step comprises operating said at least one stationary node to use a protocol which is based on an Optimized Link State Routing (OLSR) protocol to determine the plurality of communication routes.

14. A method as claimed in claim 11, further comprising:
operating said at least one stationary node to use the plurality of communication routes to support multiple levels of quality of service (QoS).

15. A method as claimed in claim 11, further comprising:
operating said at least one stationary node to forward data packets on the plurality of communication routes at the same time for load balancing.

16. A method as claimed in claim 11, wherein:
said operating step comprises operating said at least one stationary node to send at least one scouting packet toward said at least one other stationary node to collect information related to routing to determine the plurality of communication routes.

17. A method as claimed in claim 16, wherein:
the information related to routing comprises at least one of the following pertaining to a communication route that said at least one node is determining whether to select as one of the plurality of communication routes: quality of service (QoS) information; routing metrics; minimum throughput the communication route can support; maximum delay data packets may incur on the communication route; maximum jitter data packets may incur on the communication route; the maximum and minimum priority of the data which is flowing through any node along the communication route; the maximum and minimum priority of a user who is to send data though any of the node along the communication route; and a number of time slots available on the communication route when time-division multiple access (TDMA) multi access control (MAC) is used along the route.

18. A method as claimed in claim 11, further comprising:
operating said at least one stationary node to send information pertaining to the plurality of communication routes for receipt by at least one of another stationary node and a mobile node.

19. A method as claimed in claim 11, further comprising:
operating at least one of the mobile nodes to send a message to said at least one stationary node to request a route; and
operating said at least one stationary node, in reply to the message, to send to said at least one mobile node a message including information pertaining to the plurality of communication routes.

20. A method as claimed in claim 11, wherein:
at least one of the stationary nodes is an access point which is adapted to provide any of the mobile nodes that is associated therewith with access to a network other than the wireless multihopping communication network; and
said operating step comprises operating each of the stationary nodes other than the access point to determine and maintain a respective plurality of communication routes to at least one other stationary node that is an access point.
